(19) United States
(12) Patent Application Publication
(10) Pub. No.: US 2003/0164478 A1
(43) Pub. Date: Sep. 4, 2003

(54) Redispersible dispersion powder composition method for the production and use thereof

(76) Inventors: Wolfgang Fiedler, Eppstein (DE); Ulrich Geissler, Hochheim (DE); Ludwig Schmitz, Burstadt (DE)

Correspondence Address: MUSERLIAN AND LUCAS AND MERCANTI, LLP, 600 THIRD AVENUE, NEW YORK, NY, 10016, US

(21) Appl. No.: 10/398,095

(22) PCT Filed: Sep. 27, 2001
(86) PCT No.: PCT/EP01/11191

(30) Foreign Application Priority Data
Oct. 2, 2000 (DE) 10049127.8

(51) Int. Cl. H01B 1/00

(52) U.S. Cl. 252/500

(57) ABSTRACT

The present invention relates to a water-dispersible dispersion powder composition based on water-insoluble polymers, and comprising, based on the total weight of the polymer, from 0.1 to 30% by weight of at least one carboxylic ester whose alcohol component derives from the group consisting of the polyhydroxy compounds, and to a process for preparing the composition, and also to the use of the composition, in particular for reducing the water absorption of construction compositions.

The present invention relates to a water-redispersible dispersion powder composition based on water-insoluble polymers, to a process for preparing the composition, and also to the use of the composition, in particular for reducing the water absorption of construction compositions.

Water-redispersible dispersion powder compositions based on homo- and copolymers are known. Dispersion powder compositions of this type are prepared by spray drying the appropriate aqueous polymer dispersions in a hot stream of air. The dispersion powders are suitable additives for hydraulic binders in the construction materials industry. Products of this type are also used as binders in coating compositions or in adhesive compositions.

EP-A-0 741 760 describes water-redispersible dispersion powders based on film-forming, water-insoluble vinyl and/or acrylic polymers which contain organic silicon compounds, in particular organoorganoxysilanes as hydrophobicizing agent. These powders are prepared by spray drying the aqueous mixtures of aqueous dispersions of the vinyl and/or acrylic polymers to which the organic silicon compounds have been added prior to atomization. A disadvantage in the use of organosilicon compounds is their poor biodegradability and the unfavorable ecobalance arising in their preparation, which generates pollutants.

It is an object of the present invention, therefore, to provide water-redispersible dispersion powder compositions based on water-insoluble polymers, which do not have the abovementioned disadvantages but nevertheless have hydrophobicizing action in construction compositions.

The present invention therefore provides a water-redispersible dispersion powder composition based on water-insoluble polymers, and comprising, based on the total weight of the polymer, from 0.1 to 30% by weight of at least one carboxylic ester whose alcohol component derives from the group consisting of the polyhydroxy compounds.

Particular preference is given to a dispersion powder composition comprising

a) at least one water-insoluble polymer selected from the group consisting of the vinyl ester, vinyl ester-ethylene, vinyl chloride, (meth)acrylate, styrene-(meth)acrylate homo- and/or copolymers,

b) from 0 to 35% by weight, preferably from 3 to 15% by weight, based on the total weight of the polymer, of at least one protective colloid,

c) from 0.1 to 30% by weight, preferably from 0.5 to 10% by weight, based on the total weight of the polymer, of at least one carboxylic ester whose alcohol component derives from the group consisting of the polyhydroxy compounds and which has between 0 and 80 polyethylene oxide units between carboxylic acid and alcohol component, and

d) from 0 to 30% by weight, preferably from 1 to 20% by weight, based on the total weight of the polymer, of anticaking agents.

Suitable water-insoluble polymers are homo- or copolymers that are in the form of an aqueous dispersion or that can be converted into an aqueous dispersion, and which, where appropriate at an elevated temperature and/or in an alkaline medium, and after drying and, where appropriate, curing, form a solid film. The average particle size of the powder is preferably from 1 to 1000 μm, particularly preferably from 10 to 700 μm, and in particular from 50 to 500 μm.

Preferred water-insoluble polymers are:

vinyl ester homo- or copolymers containing one or more monomer units selected from the group consisting of the vinyl esters of unbranched or branched alkylcarboxylic acids having from 1 to 15 carbon atoms;

vinyl ester homo- or copolymers containing one or more monomer units selected from the group consisting of the vinyl esters of unbranched or branched alkylcarboxylic acids having from 1 to 15 carbon atoms and ethene;

vinyl ester homo- or copolymers containing one or more monomer units selected from the group consisting of the vinyl esters of unbranched or branched alkylcarboxylic acids having from 1 to 15 carbon atoms and (meth)acrylates;

vinyl ester homo- or copolymers containing one or more monomer units selected from the group consisting of the vinyl esters of unbranched or branched alkylcarboxylic acids having from 1 to 15 carbon atoms, (meth)acrylates and ethene;

(meth)acrylate homo- or copolymers containing one or more monomer units selected from the group consisting of the methacrylates and acrylates of unbranched or branched alcohols having from 1 to 12 carbon atoms;

(meth)acrylate homo- or copolymers containing one or more monomer units selected from the group consisting of the methacrylates and acrylates of unbranched or branched alcohols having from 1 to 12 carbon atoms and styrene;

homo- or copolymers of fumaric and/or maleic mono- or diesters of unbranched or branched alcohols having from 1 to 12 carbon atoms;

homo- or copolymers of dienes, e.g. butadiene or isoprene, or else of olefins, e.g. ethene or propene, where the dienes may be copolymerized with, for example, styrene, (meth)acrylates, or with the esters of fumaric or maleic acid;

homo- or copolymers of vinylaromatics, e.g. styrene, methylstyrene, or vinyltoluene;

homo- or copolymers of vinyl halogen compounds, e.g. vinyl chloride.

Water-insoluble, film-forming polyaddition or polycondensation polymers are likewise suitable, e.g. polyurethanes, polyesters, polyethers, polyamides, melamine-formaldehyde resins, and phenyl-formaldehyde resins, and, where appropriate, the oligomeric precursors of these.

Preferred vinyl esters are vinyl acetate, vinyl propionate, vinyl butyrate, vinyl 2-ethylhexanoate, vinyl laurate, 1-methylvinyl acetate, vinyl pivalate and vinyl esters of α,α-dialkyl-branched monocarboxylic acids having up to 15 carbon atoms, such as VeoVa9®, VeoV10®, or VeoVa11®. Particular preference is given to vinyl acetate and VeoVa10®.

Preferred methacrylates and acrylates are methyl acrylate, methyl methacrylate, ethyl acrylate, ethyl methacrylate, propyl acrylate, propyl methacrylate, n-butyl acrylate, tert-butyl acrylate, n-butyl methacrylate, tert-butyl methacrylate, and 2-ethylhexyl acrylate. Particular preference is given to methyl methacrylate, n-butyl acrylate, and 2-ethylhexyl acrylate.

Preferred ester groups of fumaric or maleic acid are methyl, ethyl, n-propyl, isopropyl, n-butyl, isobutyl, tert-butyl, hexyl, ethylhexyl, and dodecyl.

The vinyl ester copolymers may contain from 1.0 to 65% by weight, based on the total weight of the comonomer phase, of α-olefins, e.g. ethene and propene, and/or vinylaromatics, e.g. styrene, and/or vinyl halides, e.g. vinyl chloride, and/or acrylates of alcohols having from 1 to 12 carbon atoms, or methacrylates of these alcohols, e.g. methyl acrylate, methyl methacrylate, ethyl acrylate, ethyl methacrylate, propyl acrylate, propyl methacrylate, n-butyl acrylate, tert-butyl acrylate, n-butyl methacrylate, tert-butyl methacrylate or 2-ethylhexyl acrylate, and/or ethylenically unsaturated dicarboxylic acids and/or derivatives of these, e.g. diisopropyl fumarate, dimethyl, methyl tert-butyl, di-n-butyl, di-tert-butyl, or diethyl maleate and/or fumarate, or maleic anhydride.

The (meth)acrylate copolymers may contain from 1.0 to 65% by weight, based on the total weight of the monomers, of α-olefins, e.g. ethene and propene, and/or vinylaromatics, e.g. styrene, and/or vinyl halides, e.g. vinyl chloride, and/or ethylenically unsaturated dicarboxylic acids and/or derivatives of these, e.g. diisopropyl fumarate, dimethyl, methyl tert-butyl, di-n-butyl, di-tert-butyl, and diethyl maleate and/or fumarate, or maleic anhydride.

The vinyl ester copolymers and (meth)acrylate copolymers may moreover contain from 0.05 to 10.0% by weight, based on the total weight of the comonomer mixture, of auxiliary monomers from the group consisting of the ethylenically unsaturated carboxylic acids, preferably acrylic acid or methacrylic acid, from the group consisting of the ethylenically unsaturated carboxamides, preferably acrylamide, from the group consisting of the ethylenically unsaturated sulfonic acids and salts of these, preferably vinylsulfonic acid or 2-acrylamido-2-methylpropanesulfonic acid (AMPS), and/or from the group consisting of the multiply ethylenically unsaturated comonomers, such as divinyl adipate, diallyl maleate, allyl methacrylate, or triallyl cyanurate. Other suitable auxiliary monomers are crosslinking comonomers, e.g. acrylamidoglycolic acid (AGA), methyl methacrylamidoglycolate (MAGME), N-methylolacrylamide (NMAA), N-methylolmethacrylamide, allyl N-methylolcarbamate, alkyl ethers, e.g. the isobutoxy ether, or esters of N-methylolacrylamide, of N-methylolmethacrylamide, or of allyl N-methylolcarbamate. The same applies to the copolymers of the maleic or fumaric esters.

The water-insoluble polymers mentioned are capable of free-radical polymerization and are preferably prepared by emulsion polymerization. This polymerization may be carried out batchwise or continuously, with or without the use of seed lattices, the initial charge comprising one or more, or all, of the constituents of the reaction mixture, or by the feed process with no initial charge. The rate of each feed preferably corresponds to the consumption of the respective component. The polymerization is preferably carried out in the temperature range from 0 to 100° C. and initiated by the methods usually used for emulsion polymerization. It is usually initiated by means of conventional water-soluble free-radical generators, preferably used in amounts of from 0.01 to 3.0% by weight, based on the total weight of the monomers. Examples of suitable water-soluble initiators are sodium peroxodisulfate, potassium peroxodisulfate, and ammonium peroxodisulfate, and also water-soluble azo initiators such as 2,2′-azobis(2-amidinopropane) dihydrochloride. Suitable monomer-soluble initiators are organic hydroperoxides, e.g. tert-butyl hydroperoxide and cumene hydroperoxide, organic peroxides, e.g. dibenzoyl peroxide and dilauroyl peroxide, and monomer-soluble azo compounds, e.g. azo-bisisobutyronitrile. The initiators may be used together with reducing agents, such as sodium bisulfite and sodium hydroxymethanesulfinate. Any protective colloids and/or emulsifiers usually used in emulsion polymerization may be used as dispersing agents.

Where appropriate, up to 6% by weight of emulsifiers are used, based on the total weight of the monomers. The emulsifiers used here may be either anionic, cationic, or nonionic emulsifiers, as long as these are not soluble in the protective colloid.

It is preferable to use protective colloids, particularly preferably in amounts of up to 15% by weight, based on the total weight of the monomers. Examples of suitable protective colloids are polyvinyl alcohols and derivatives of these, such as vinyl alcohol-vinyl acetate copolymers, polyvinylpyrrolidones, polysaccharides, e.g. starches (amylose and amylopectin), cellulose, guar, tragacantic acid, dextran, alginates and carboxymethyl, methyl, hydroxyethyl, or hydroxypropyl derivatives, proteins, e.g. casein, soya protein, gelatins, synthetic polymers, e.g. poly(meth)acrylic acid, poly(meth)acrylamide, polyvinylsulfonic acids, and water-soluble copolymers of these, melamine-formaldehydesulfonates, naphthalene-formaldehydesulfonates, styrene/maleic acid copolymers, and vinyl ether-maleic acid copolymers. Polyvinyl alcohol is particularly preferred as protective colloid for the polymerization. A particular protective colloid used is a polyvinyl alcohol with a degree of polymerization of from 200 to 3 500 and with a degree of hydrolysis of from 80 to 98 mol %.

For the purposes of the present invention, polyhydroxy compounds are defined as any of the low-molecular-weight or macromolecular organic compounds whose molecule contains two or more hydroxyl groups (Römpp Lexikon Chemie [Römpp Encyclopedia of Chemistry]—Version 2.0, Stuttgart/New York: Georg Thieme Verlag 1999). The polyhydroxy compounds are also termed polyols and for the purposes of the present invention the definition includes polyhydric alcohols, such as glycerol and pentaerythritol, phenols, such as polyphenols, sugar alcohols, carbohydrates, natural polymers, such as polysaccharides, cellulose, and starch, and synthetic polymers, such as polyvinyl alcohol.

The polyhydroxy component used in the carboxylic ester is preferably glycerol, diglycerol, polyglycerol, erythritol, pentaerythritol, xylitol, sorbitol, sorbitans, mannitol, sucrose, or other glycosides. Particular preference is given to esters of sorbitol, of the sorbitans, of glycerol, and of diglycerol. Particular preference is given to esters of the sorbitans and of glycerol.

Both the acid component and the alcohol component of the carboxylic ester may be either saturated or unsaturated, and branched or unbranched. The acid radical and the alcohol radical may also contain halogens, such as fluorine or chlorine, and also ether groups, thioether groups, ester groups, amide groups, carboxy groups, sulfonic acid groups, carboxylic anhydride groups, or carbonyl groups, and the acid radical may also contain hydroxyl groups.

The polyhydroxy compounds may have been esterified at any hydroxyl group, and therefore use may be made of the di-, tri- or polyesters as well as of the monoesters. However, it is preferable to use the monoesters.

To improve water-solubility, the carboxylic esters may contain polyethylene oxide units as spacers between carboxylic acid component and alcohol component. The number of polyethylene oxide units is generally from 1 to 80, preferably from 2 to 40.

If solubility in water is sufficient, it is preferable for the polyhydroxy carboxylic esters to be added in pure form to the emulsion polymer. Otherwise, the carboxylic esters are added in emulsified form. For the emulsification it is preferable to use protective colloids, where appropriate combined with suitable emulsifiers. Emulsifiers used here may be either anionic, cationic, or nonionic emulsifiers.

It is also preferable for the carboxylic esters to be added to the aqueous phase of the emulsion polymerization. The carboxylic esters may also be used as a feed during the emulsion polymerization.

In another embodiment, the carboxylic esters are applied to a solid carrier, as described in detail in DE-A-195 35 833 and DE-A-197 52 659. These carriers are anticaking agents, and also magnesium hydrosilicates, fine-particle titanium dioxide, aluminas, bleaching earths, activated aluminum oxide, vermiculite, such as bentonite, expanded perlite, and also phosphates, such as Na-phosphate. Particular preference is given to silicas with a BET surface area of at least 50 m²/g, in particular at least 100 m²/g. The amount of carboxylic ester added is from 10 to 160% by weight, based on the weight of the carrier material used.

These coated products are either used as anticaking agents and admixed during the atomization process, or are added to the finished dispersion powder.

In one preferred embodiment, the dispersion powder composition comprises from 0 to 35% by weight, particularly preferably from 3 to 15% by weight, of protective colloid, based on the total amount of water-insoluble polymer. Examples of suitable protective colloids are polyvinyl alcohols and derivatives of these, such as vinyl alcohol-vinyl acetate copolymers, polyvinylpyrrolidones, polysaccharides, such as starches (amylose and amylopectin), cellulose, guar, tragacantic acid, dextran, alginates, and carboxymethyl, methyl, hydroxyethyl, or hydroxypropyl derivatives, proteins, such as casein, soya protein, gelatin, synthetic polymers, such as poly(meth)acrylic acid, poly(meth)acrylamide, polyvinylsulfonic acids, and water-soluble copolymers of these, melamine-formaldehydesulfonate, naphthaline-formaldehydesulfonate, styrene-maleic acid copolymers and vinyl ether-maleic acid copolymers.

Preferred suitable anticaking agents are aluminum silicates, calcium carbonates and magnesium carbonates and mixtures of these, silicas, and combinations of dolomite and, respectively, calcite and talc. The particle size of the anticaking agents is preferably from 0.001 to 0.5 mm.

The dispersion powder composition is preferably prepared by spray drying. This drying takes place in conventional spray drying systems, using atomization by means of single-, twin-, or multiple-fluid nozzles or by a rotating disk. The discharge temperature selected is generally in the range from 50 to 100° C., preferably from 60 to 90° C., depending on the system, the glass transition temperature of the resin, and the desired degree of drying. To increase the storage stability and flowability of the dispersion powder it is preferable to introduce an anticaking agent into the spray tower in parallel with the dispersion, the result being the preferred deposition of the anticaking agent onto the dispersion particles.

The dispersion powder composition may be used in the typical application sectors, for example in construction chemistry products in combination with inorganic, hydraulically setting binders, such as cements (Portland, alumina, pozzilanic, slag, magnesia, or phosphate cement), gypsum plaster, waterglass, for producing construction adhesives, renders, troweling compounds, floor-filling compositions, jointing mortars, or paints, or else as sole binders for coating compositions or adhesive compositions, or as binder for textiles. The dispersion powder composition is preferably used as a hydrophobicizing binder in application sectors where, besides good adhesion, reduced water absorption and/or a water-repellent effect is desirable.

The invention is described in further detail below using examples, but is not limited by these. The parts and percentages stated in the examples are based on weight unless otherwise stated.

### EXAMPLE 1

1 300 parts of a polyvinyl alcohol-stabilized dispersion based on vinyl acetate, vinyl 10-versatate, and butyl acrylate (45:45:10), solids content: 54.1%, viscosity (Haake VT 500, 386.6 s⁻¹): 1 150 mPas, Tg: 13° C., particle size distribution: d_{w}: 1 863 nm, d_{w}/dₙ: 12.8, preparation based on example 1 of EP-A-0 761 697, are treated with 140 parts of a 25% strength polyvinyl alcohol solution (viscosity of 4% strength aqueous solution at 20° C.: 4 mPas, degree of hydrolysis: 88%, degree of polymerization: 630).

The following amounts of a sorbitan ester of lauric acid (®Disponil SML 100N from Cognis) are added to the mixture:

| Example No. | Parts of sorbitan laurate |
|---|---|
| 1a | 0 |
| 1b | 18.5 |
| 1c | 36.9 |
| 1d | 73.8 |

The mixtures are diluted with deionized water to 40% solids content and spray-dried with addition of an anticaking mixture of talc and dolomite (spray drier from Niro, inlet temperature: 130° C., discharge temperature: 65° C., throughput: 1 kg of dispersion/hour). The content of anticaking agent is 15%.

The dispersion powders isolated are used in hydraulically setting compositions, and water absorption values are determined as follows:

A premix is prepared by homogenizing

| | | |
|---|---|---|
| 300 | parts | Portland cement CEM I 42.5 R |
| 2 | parts | ® Tylose MH 15002 P6 |
| 200 | parts | Quartz sand F 31 |
| 368 | parts | Quartz sand F 34 |
| 100 | parts | Omyacarb 20 GU |

in a Lödige (model M5R) mixer for 3 minutes at scale setting 8.5. 200—x parts of premix are mixed with x parts of dispersion powder and, after addition of 40 parts of water, stirred for 15 seconds at a high rotation rate using a Lenart stirrer (Vollrath, model EWTHV-1). The composition is allowed to age for 5 minutes, and is then stirred again manually.

On top of a sheet of EPS, 2 cm in thickness, is placed a template of dimension 0.5×10×20 cm, into which an amount of the composition is uniformly charged and smoothed. After overnight standing, the specimen is cut out and edge-sealed with molten paraffin wax. The sealed specimens are stored at 23° C., first for 3 days in a water-vapor-saturated atmosphere, then for 3 days at 50% rel. humidity.

The specimens are then weighed and then placed with their test surfaces downward in a water-filled basin. After 1 and, respectively, 24 h the specimens are removed, damped dry with a sponge wipe, and weighed. The increase in weight is converted to g/m².

The water absorption values found for the mortar compositions formulated using the powders1a to 1d are given in table 1 below:

It can be seen that water absorption decreases markedly as the amount of hydrophobicizing agent (powders 1a to 1d) rises. Water absorption also decreases as the content of dispersion powder used increases.

TABLE 1

| | x parts of | | |
|---|---|---|---|
| | dispersion | Water absorption | Water absorption |
| Example No. | powder | 1 h (g/m²) | 24 h (g/m²) |
| 1a | 1 | 920 | 1015 |
| (comparison) | | | |
| 1a | 2 | 961 | 1031 |
| (comparison) | | | |
| 1a | 4 | 869 | 977 |
| (comparison) | | | |
| 1a | 6 | 452 | 712 |
| (comparison) | | | |
| 1b | 1 | 842 | 940 |
| 1b | 2 | 606 | 826 |
| 1b | 3 | 351 | 654 |
| 1b | 4 | 216 | 432 |
| 1b | 5 | 118 | 326 |
| 1b | 6 | 112 | 337 |
| 1c | 1 | 758 | 911 |
| 1c | 2 | 382 | 655 |
| 1c | 3 | 200 | 405 |
| 1c | 4 | 112 | 374 |
| 1c | 5 | 106 | 328 |
| 1c | 6 | 93 | 269 |
| 1d | 1 | 474 | 712 |
| 1d | 2 | 215 | 398 |
| 1d | 3 | 143 | 354 |
| 1d | 4 | 108 | 318 |
| 1d | 5 | 107 | 288 |
| 1d | 6 | 73 | 223 |

### EXAMPLE 2

As in example 1, a dispersion is prepared, but the polymerization is carried out in the presence of 2.5 parts of sorbitan ester of lauric acid, based on the total weight of the monomers.

1300 parts of the polymer prepared using sorbitan ester of lauric acid and based on vinyl acetate, vinyl 10-Versatate, and butyl acrylate (45:45:10) are mixed with 140 parts of a 25% strength polyvinyl alcohol solution (viscosity of 4% strength aqueous solution at 20° C.: 4 mPas, degree of hydrolysis: 88%, degree of polymerization: 630).

The mixture is diluted with deionized water to 40% solids content and spray dried as described in example 1.

The dispersion powder isolated is used, as described in example 1, in a hydraulically setting composition, and water absorption is determined:

| | Parts | | |
|---|---|---|---|
| | of dispersion | Water absorption | Water absorption |
| Example No. | powder | 1 h (g/m²) | 24 h (g/m²) |
| 1a | 6 | 452 | 712 |
| (comparison) | | | |
| 2 | 6 | 113 | 367 |

Here again, it can be seen that there is markedly reduced water absorption when the hydrophobicized powder is used.

### EXAMPLE 3

50 parts of ®Sipernat 22 (precipitated silica with a BET surface area of 190 m²/g, average agglomerate size 100 μm, 98% SiO₂) are charged to a kitchen machine and 50 parts of sorbitan ester of lauric acid are added dropwise at room temperature within a period of 5 minutes. Stirrer rate: setting 2. After continued stirring for 3 minutes the pulverulent mixture is discharged.

A mixture of equal parts of dispersion powder 1 a and the abovementioned pulverulent mixture is homogenized in a ratio of 1:1, and 4 parts of this are added to the hydraulically setting compositions described in example 1.

The table below gives water absorption in comparison with that of a composition modified with dispersion powder only:

| | Parts | | |
|---|---|---|---|
| | of dispersion | Water absorption | Water absorption |
| Example No. | powder | 1 h (g/m²) | 24 h (g/m²) |
| 1a | 2 | 961 | 1031 |
| (comparison) | | | |
| 3 | 2 | 107 | 250 |

Comparable results are obtained if the pulverulent mixture is used as anticaking agent during the atomization to give the dispersion.

1. A dispersion powder composition based on water-insoluble polymers and comprising, based on the total weight of the polymer, from 0.1 to 30% by weight of at least one carboxylic ester whose alcohol component derives from the group consisting of the polyhydroxy compounds, and wherein the polymer is stabilized by means of protective colloids.

2. The dispersion powder composition as claimed in claim 1, wherein the dispersion powder composition comprises
a) at least one water-insoluble polymer selected from the group consisting of the vinyl ester, vinyl ester-ethylene, vinyl chloride, (meth)acrylate, styrene-(meth)acrylate homo- and/or copolymers,
b) from 3 to 35% by weight, based on the total weight of the polymer, of at least one protective colloid,
c) from 0.1 to 30% by weight, based on the total weight of the polymer, of at least one carboxylic ester whose alcohol component derives from the group consisting of the polyhydroxy compounds and which has between 0 and 80 polyethylene oxide units between carboxylic acid component and alcohol component
d) from 0 to 30% by weight, based on the total weight of the polymer, of anticaking agents.

3. The dispersion powder composition as claimed in claim 1 or 2, wherein the polymer is additionally stabilized by means of emulsifiers.

4. The dispersion powder composition as claimed in at least one of the preceding claims, wherein polyvinyl alcohol with a degree of polymerization of from 200 to 3 500 and a degree of hydrolysis of from 80 to 98 mol % is used as protective colloid for preparing the polymer.

5. The dispersion powder composition as claimed in at least one of the preceding claims, wherein the polyhydroxy component of the carboxylic ester derives from the group consisting of the sorbitans.

6. The dispersion powder composition as claimed in claim 5, wherein the carboxylic ester is a sorbitan ester of lauric acid.

7. The dispersion powder composition as claimed in at least one of claims 1 to 4, wherein the polyhydroxy component of the carboxylic ester is glycerol.

8. The dispersion powder composition as claimed in at least one of the preceding claims, wherein the acid component and the alcohol component contain halogens, hydroxyl groups, ether groups, thioether groups, ester groups, amide groups, carboxy groups, sulfonic acid groups, carboxylic anhydride groups, and/or carbonyl groups.

9. The dispersion powder composition as claimed in at least one of the preceding claims, wherein the carboxylic ester used comprises the appropriate monoester of the polyhydroxy compounds.

10. The dispersion powder composition as claimed in at least one of the preceding claims, wherein the carboxylic ester is added to the initial charge for the polymer a) needed for the preparation process.

11. The dispersion powder composition as claimed in at least one of the preceding claims, wherein aluminum silicate, calcium carbonate or magnesium carbonate or mixtures of these, silicas, or combinations of dolomite and, respectively, calcite and talc are used as anticaking agents.

12. The dispersion powder composition as claimed in at least one of the preceding claims, wherein the carboxylic acid has been applied to a pulverulent carrier material, with the proviso that this carrier material comprises from 10 to 160% by weight of carboxylic ester, based on the total weight of the carrier material.

13. The dispersion powder composition as claimed in claim 12, wherein the pulverulent carrier material is an anticaking agent as claimed in claim 11.

14. The dispersion powder composition as claimed in claim 12, wherein the carrier material used comprises fumed silica or precipitated silica with a BET surface area of at least 50 m²/g.

15. A process for preparing a dispersion powder composition as claimed in claim 1, in which polymer a), protective colloid b), and carboxylic esters c), and, if desired, further protective colloid b) are mixed to prepare a dispersion and this is then, where appropriate, dried with simultaneous admixing of the anticaking agent d).

16. The process as claimed in claim 15, wherein the carboxylic ester is applied to a carrier material and this coated material is added during and/or after the drying process.

17. The process as claimed in claim 16, wherein the coated material is added after the drying of the dispersion powder composition.

18. The process as claimed in at least one of claims 15 to 17, wherein the drying process takes place by spray drying in a drying tower.

19. The use of a dispersion powder composition as claimed in at least one of claims 1 to 14 for modifying wallpaper pastes, mortar, or concrete.

20. The use of a dispersion powder composition based on water-insoluble polymers, which composition comprises, based on the total weight of the polymer, from 0.1 to 30% by weight of at least one carboxylic ester whose alcohol component derives from the group consisting of the polyhydroxy compounds, for hydrophobicizing mortar or concrete.
